(19) United States
(12) Patent Application Publication
(10) Pub. No.: US 2010/0180803 A1
(43) Pub. Date: Jul. 22, 2010

(54) Method and Plant for the Simultaneous Production of Electricity and Cement Clinker

(75) Inventor: Jens Peter Hansen, Aalborg (DK)

Correspondence Address: FLSMIDTH, 2040 Avenue C, Bethlehem, PA, 18017, US

(73) Assignee: FLSMIDTH A/S, Valby (DK)

(21) Appl. No.: 12/664,070

(22) PCT Filed: Apr. 28, 2008
(86) PCT No.: PCT/EP08/55134

§ 371 Date: Dec. 11, 2009

(30) Foreign Application Priority Data
Jun. 12, 2007 (DK) PA200700839

(51) Int. Cl. C04B 2/10

(52) U.S. Cl. 106/771

(57) ABSTRACT

Described is a method as well as a plant for the simultaneous production of electricity and cement clinker by which method cement raw meal is calcined in a calciner (4) subject to simultaneous supply of fuel and combustion air and subsequently burned into cement clinker in a kiln (5), and where some of the heat contained in the exhaust gases from the calciner (4) is utilized to generate electricity by means of a boiler section (18). The method and plant are peculiar in that the combustion air supplied to the calciner (4) does not contain alkali or chloride, and in that the temperature of the exhaust gases used to generate electricity is at least 500° C.

Coating formations formed on the boiler tubes due to the condensation of alkali and chloride vapours can be avoided, while, at the same time, the efficiency with which thermal energy can be converted into electrical energy can be increased.

### CROSS-REFERENCE TO RELATED APPLICATIONS

This application is the United States national phase under 35 U.S.C. §371 of International Patent Application No. PCT/EP2008/055134, filed on Apr. 28, 2008 and claiming priority to Danish Patent Application No. PA200700839, filed on Jun. 12, 2007.

### BACKGROUND OF THE INVENTION

1. Field of the Invention

Embodiments presented herein relate to a method for the simultaneous production of electricity and cement clinker.

2. Background of the Art

Known for example from GB-2098305-A and EP-896958-A1 are plants utilizing exhaust gases from the kiln system of the cement manufacturing plant to generate electricity. The electricity is typically generated in a steam turbine, with the evaporation of water or other working medium for same occurring in one or several boiler sections. In GB-2098305-A it is proposed that a boiler section is installed between the first and second stage in a cyclone preheater tower where the temperature of the gases is at least 500° C., whereas in EP-896958-A1 it is proposed that some of the hot exhaust gases having a temperature within the range of 700 and 900° C. from a bottom stage cyclone are diverted in relation to the preheater tower and utilized to generate electricity. It is a well-known fact that the efficiency with which thermal energy can be converted into electrical energy increases substantially in relation to the inlet temperature of the process gas which is introduced into a boiler section. Two significant problems associated with the attempt to raise the temperature of the superheated steam involve contamination and erosion of the boiler tubes when the temperature of the exhaust gases is increased. Normally, the steam is contained within a group of boiler tubes, while the hot exhaust gases are cooled when passing the outer side of these boiler tubes. It has thus been discovered that the heat transfer for these known plants decreases substantially over time because of the coatings formed on the outer side of the boiler tubes.

More detailed studies of these coatings have shown that the most commonly occurring elements in these coatings are alkali, chloride and sulphur. These elements evaporate at temperatures higher than 900° C. in the burning zone of the kiln system and gradually undergo condensation as the exhaust gases are cooled as they pass through the calciner and the preheater cyclones, and, unfortunately, also on a boiler section, if incorporated, fitted at a location where the exhaust gas temperature is higher than 500° C. Many different compounds such as KCl, CaCl₂, NaCl, Na₂CO₃, K₂SO₄ and Na₂SO₄ may be formed if exhaust gases containing such elements are subjected to cooling.

The aforementioned problem involving formation of coatings on the boiler tubes can be avoided by fitting the boiler section at a location where the temperature of the exhaust gases is lower than 500° C., where the main part of the alkali and chloride has undergone condensation. However, the disadvantage of this method is that the efficiency will be so low as to virtually eliminate any economic benefit.

### BRIEF SUMMARY OF THE INVENTION

Embodiments of the invention relate to methods and plants for the simultaneous production of electricity and cement clinker. Cement raw meal is calcined in a calciner subject to simultaneous supply of fuel and combustion air and subsequently burned into cement clinker in a kiln, where some of the heat contained in the exhaust gases from the calciner is utilized to generate electricity by means of a boiler section. Embodiments also relate to a plant for carrying out the method.

### BRIEF DESCRIPTION OF THE DRAWING

FIG. 1 shows a diagram of a cement manufacturing plant as shown and described herein.

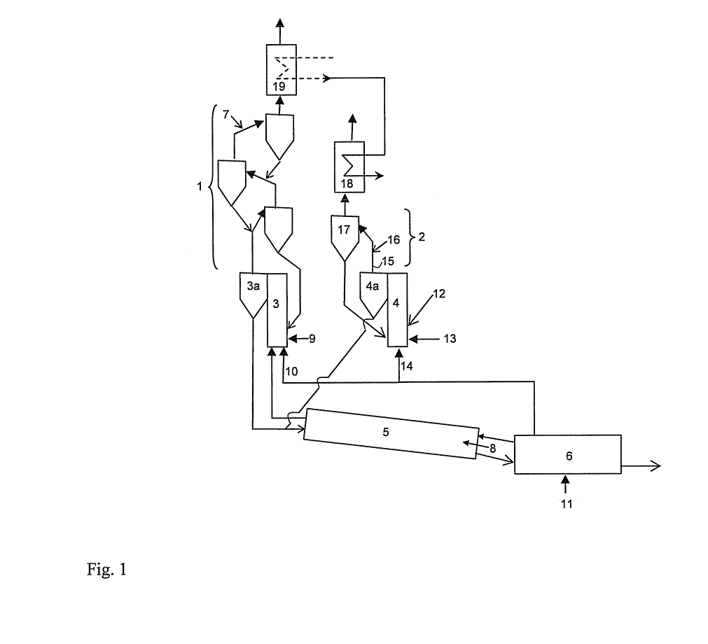

### DETAILED DESCRIPTION OF THE INVENTION

Embodiments of the invention may provide a method as well as a plant for the simultaneous production of electricity and cement clinker by means of which the aforementioned disadvantages are eliminated or significantly reduced.

In one embodiment, the combustion air as well as the cement raw meal supplied to the calciner does not contain alkali or chloride, and the temperature of the exhaust gases used to generate electricity is at least 500° C.

Coating formations formed on the boiler tubes due to the condensation of alkali and chloride vapours can be avoided, while, at the same time, the efficiency with which thermal energy can be converted into electrical energy can be increased. This the case because in contrast to other previously known plants exhaust gases containing alkali and chloride from the rotary kiln of the cement manufacturing plant are not utilized to generate electricity, but instead an exhaust gas without any content of such elements.

A plant for carrying out the method according to the invention comprises a calciner for calcination of cement raw meal subject to simultaneous supply of fuel and combustion air and a boiler section used to produce steam for generating electricity by means of some of the heat contained in the exhaust gases from the calciner, and being characterized in that the combustion air as well as the cement raw meal being supplied to the calciner does not contain alkali and chloride and in that the temperature of the exhaust gases utilized to generate electricity is at least 500° C.

The combustion air which is supplied to the calciner may be atmospheric air which may be heated in a heat generator. However, as combustion air in the calciner it is preferred to use process gases from the cement manufacturing plant itself, preferably from the clinker cooler.

In instances where the cement raw meal contains contaminants in the form of sulphide and organic carbon, there will be a tendency for these elements to be discharged as gaseous sulphur dioxide (SO₂), carbon monoxide (CO) and volatile organic compounds (VOC), if they are heated in a traditional multi-stage cyclone preheater. To avoid such emissions, raw meal which contains such contaminants and which has been preheated to a level of maximum 500° C. may advantageously be introduced directly into a process gas having a high temperature of at least 800° C. and containing calcium oxide dust (CaO) and a surplus of oxygen. Hence the gaseous SO₂ will absorb on the calcium oxide dust and the organic carbon will burn completely into carbon dioxide (CO₂), thereby considerably reducing or completely eliminating emissions of SO₂, CO and VOC. According to the invention it is therefore preferred that cement raw meal which contains contaminants in the form of sulphide and organic carbon are introduced directly into the calciner where the aforementioned conditions are present.

In situations where it is desirable to use low-grade fuels for the cement manufacturing process, such fuels may also advantageously be fired directly in the calciner where the appropriate conditions in the form of a substantial oxygen surplus to ensure complete burnout of such fuels are present.

The exhaust gases which are discharged from the calciner will typically have a temperature of at least 850° C. In instances where it is desirable to lower this temperature prior to introducing the exhaust gases into the boiler section, the plant may be formed with one or several cyclone stages for preheating cement raw meal, preferentially cement raw meal which does not contain any appreciable amounts of contaminants in the form of sulphide and organic carbon prior to being introduced into the calciner. In this way, the temperature of the exhaust gases may be adjusted in optimum manner for the subsequent heat exchange process in the boiler section.

The cement manufacturing plant may further comprise a conventional cyclone preheater which is fed with the alkali- and chloride-laden exhaust gases from the kiln of the plant. In this case, the working medium of the boiler section may advantageously be preheated through heat exchange with the exhaust gases in the cyclone preheater at a location where the inlet temperature does not exceed 500° C. The working medium of the boiler section may also be preheated through heat exchange with the excess air from the clinker cooler.

An embodiment of the invention will now be described in further details with reference to the drawing, the only FIGURE of which being diagrammatical, and showing a cement manufacturing plant according to the invention.

In the FIGURE is seen a cement manufacturing plant which comprises two preheater strings 1 and 2, each of which comprises a calciner 3 and 4, respectively, each equipped with a separation cyclone 3a and 4a, respectively, a rotary kiln 5 and a clinker cooler 6. The preheater string 1 is designed as a traditional multi-stage cyclone preheater and in the shown embodiment it comprises three cyclone stages, but may also comprise fewer as well as additional cyclone stages. The preheater string 1 functions in the traditional manner, with cement raw meal being introduced via an inlet 7 into the inlet duct for the uppermost cyclone stage of the cyclone preheater, being heated, calcined and burned into clinker when routed through, as a first step, the preheater 1, the calciner 3 and then the rotary kiln 5 in counter-flow with hot exhaust gases which are formed at, respectively, a burner 8 in the rotary kiln 5 and a burner 9 in the calciner 3, and combustion air which is introduced into the calciner 3 via a duct 10, and being drawn through the preheater string 1 by means of a not shown fan. The burned clinker is subsequently cooled in the clinker cooler 6 by means of cooling air as indicated by the arrow 11.

In the shown embodiment, the preheater string 2 is made up of the calciner 4 with separation cyclone 4a and a single cyclone stage, but it may be constructed without any cyclone stages or with more cyclone stages. In the preheater string 2 cement raw meal is introduced via an inlet 12, possibly containing higher concentrations of volatile components in the form of sulphide and organic carbon, directly into the calciner 4, in which it is heated to a calcination temperature of approximately 890° C. subject to simultaneous supply of fuel via one or several burners 13 and combustion air via a duct 14. The calcined raw meal is separated from the exhaust gases in the separation cyclone 4a and directed to the rotary kiln 5 in which it is burned into clinker together with the raw meal from the preheater string 1, whereas the exhaust gases are diverted via an exhaust gas duct 15. The exhaust gases leaving the calciner 4 via the duct 15 have a temperature of at least 850° C. and may possibly be used for preheating raw meal which is introduced via an inlet 16 into the duct 15, thereby lowering the temperature of the exhaust gases, and again separated from the exhaust gases in a subsequent cyclone 17. The exhaust gases from the calciner 4 are routed directly or via one or several cyclone stages 17 to a boiler section 18 in which, through heat exchange, the gases are used for superheating a working medium which is subsequently used to generate electricity or other mechanical work in known manner.

According to this embodiment of the invention, the combustion air which is supplied to the calciner 4 must not contain any alkali nor chloride in order to avoid formation of coatings on the boiler tubes in the subsequent boiler section resulting from the condensation of alkali and chloride vapours, and, at the same time, the temperature of the exhaust gases utilized to generate electricity must be at least 500° C., thereby increasing the efficiency with which the thermal energy of the exhaust gases is converted into electrical energy in the boiler section.

As shown in the FIGURE, hot cooling air from the clinker cooler 6 may be appropriately used since it does not contain alkali or chloride. Alternatively, the combustion air may be atmospheric air which may be heated in a heat generator.

Cooling air from the clinker cooler has a high oxygen content and a high temperature, making it particularly suitable for use as combustion air to ensure complete burnout of low-grade fuels and of any contaminants of organic carbon in the raw materials which are introduced into the calciner 4, thereby avoiding emissions of SO₂, CO and VOC.

In the shown cement manufacturing plant, the working medium of the boiler section may advantageously be heated in a heat exchanger 19 through heat exchange with the exhaust gases from the cyclone preheater 1 before it is superheated in the boiler section 18. If this is the case, the temperature of the exhaust gases from the cyclone preheater 1 to the heat exchanger 19 should not exceed 500° C. in order to ensure that the entire content of chloride and alkali is effectively condensed before reaching the heat exchanger 19. The working medium of the boiler section may also be preheated through heat exchange with surplus air from the clinker cooler 6.

1. A method for the simultaneous production of electricity and cement clinker, comprising:
calcining cement raw meal in a calciner subject to simultaneous supply of fuel and combustion air, wherein said calciner emits exhaust gases;
burning the calcined cement raw meal into cement clinker in a kiln; and
generating electricity in a boiler section using heat contained in the exhaust gases from the calciner, wherein the combustion air and cement raw meal do not contain alkali or chloride, and wherein the temperature of the exhaust gases containing heat used to generate electricity is at least 500° C.

2. The method according to claim 1, wherein the combustion air comprises gases emitted during production of cement raw meal.

3. The method of claim 1, wherein cement raw meal which contains contaminants in the form of sulphide and organic carbon is introduced directly into the calciner.

4. The method of claim 1, further comprising firing low-grade fuels into the calciner.

5. The method of claim 1, further comprising preheating cement raw meal using the exhaust gases which are discharged from the calciner prior to using said exhaust gases to generate electricity.

6. The method of claim 1, further comprising preheating the working medium of the boiler section in a second boiler section through heat exchange with exhaust gases from an additional preheater string, which is supplied with the exhaust gases from the kiln at a process location where the inlet temperature of the exhaust gases to the second boiler section does not exceed 500° C.

7. The method of claim 1, further comprising preheating the working medium of the boiler section through heat exchange with the excess air from a clinker cooler.

8. A plant for carrying out the method of claim 1, comprising a calciner for calcination of cement raw meal subject to simultaneous supply of fuel and combustion air, and a boiler section used to produce steam for generating electricity from heat contained in the exhaust gases from the calciner, wherein the combustion air as well as the cement raw meal being supplied to the calciner do not contain alkali and chloride, and wherein the temperature of the exhaust gases utilized to generate electricity is at least 500° C.

9. The plant of claim 8, further comprising a clinker cooler, wherein the calciner is connected to the clinker cooler via a duct for supplying of cooling air from the clinker cooler to the calciner.

10. The plant of claim 8, further comprising at least one cyclone stage for preheating cement raw meal prior to introduction of the cement raw meal into the calciner.

11. The method of claim 2, wherein said gases emitted during production of cement raw meal are gases emitted from a clinker cooler.
